(19) United States
(12) Patent Application Publication
(10) Pub. No.: US 2008/0268779 A1
(43) Pub. Date: Oct. 30, 2008

(54) DAA concept with uplink detection: frequency domain quiet periods

(75) Inventors: Sandeep Rajpal, Irvine, CA (US); Siddharth Shetty, San Diego, CA (US); Gaetano Roberto Aiello, San Diego, CA (US); Timothy Leo Gallagher, Encinitas, CA (US); Nishant Kumar, San Diego, CA (US); Nicholas Michael Carbone, San Diego, CA (US); James Laurence Taylor, Sherborne (GB)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 12/080,257

(22) Filed: Mar. 31, 2008

Related U.S. Application Data
(60) Provisional application No. 60/921,164, filed on Mar. 29, 2007.
(60) Provisional application No. 60/922,736, filed on Apr. 9, 2007.
(60) Provisional application No. 60/936,408, filed on Jun. 19, 2007.

(51) Int. Cl. H04B 7/00; H04Q 7/00

(52) U.S. Cl. 455/41.2; 340/539.11

(57) ABSTRACT

A victim wireless device is detected by obtaining a set of wireless bands and a set of time periods. During a given time period a subset of wireless bands corresponding to that time period is vacant and a remaining subset of wireless bands is used to exchange data. During each of the time periods in the set of time periods: a signal, if any, is received; in the event a signal is received, the subset of vacant wireless bands corresponding to that time period is recorded; and after the set of time periods ends, it is determined whether there is a victim wireless device based at least in part on the number of vacant wireless bands recorded.

### CROSS REFERENCE TO OTHER APPLICATIONS

This application claims priority to U.S. Provisional Patent Application No. 60/921,164 (Attorney Docket No. AIELP079+) entitled DAA CONCEPT WITH UPLINK DETECTION: FREQUENCY DOMAIN QUIET PERIODS filed Mar. 29, 2007 which is incorporated herein by reference for all purposes, priority to U.S. Provisional Patent Application No. 60/922,736 (Attorney Docket No. AIELP080+) entitled PROTECTING VICTIM SERVICE CLIENTS BY INTRODUCING QUIET PERIODS DURING WIMEDIA SYSTEM OPERATION filed Apr. 9, 2007 which is incorporated herein by reference for all purposes, and priority to U.S. Provisional Patent Application No. 60/936,408 (Attorney Docket No. AIELP081+) entitled PROTECTING VICTIM SERVICE CLIENTS BY INTRODUCING ‘QUIET’ PERIODS DURING WIMEDIA SYSTEM OPERATION filed Jun. 19, 2007 which is incorporated herein by reference for all purposes.

### BACKGROUND OF THE INVENTION

Although wireless devices offer a number of conveniences over wire-line counterparts, wireless devices are susceptible to interference from other wireless devices. In the case of ultra wideband (UWB) devices (such a WiMedia UWB device) the bandwidth is on the order of 500 MHz. This is a relatively large bandwidth which may cover spectrum used by one or more victim devices. Such a victim device may be affected by the operation of the ultra wideband device to the point where it cannot communicate. Certain wireless devices are configured to wait for a particular received signal or message (e.g., from a base station) before transmitting. A downlink refers to a signal or message from the base station (i.e., master) to the slave device and an uplink refers to a signal or message from the slave device to the base station. Such victim Master-Slave systems include, for example, WiMax and 4G systems. Detection and avoidance techniques have been, and are in the process of being, developed, but it would be desirable if certain aspects could be addressed or improved upon. Some examples include being able to distinguish between a genuine victim device and some noise (also referred to as a spur) during a detection procedure and for new wireless devices (e.g., that just powered on or entered the vicinity) to start operating in a prescribed and/or well-behaved manner.

### BRIEF DESCRIPTION OF THE DRAWINGS

Various embodiments of the invention are disclosed in the following detailed description and the accompanying drawings.

FIG. 1 is a diagram illustrating an embodiment of time frequency codes (TFC) cycled through in order to detect any victim devices.

FIG. 2 is a flowchart illustrating an embodiment of a process to detect victim devices while cycling through time frequency codes.

FIG. 3 is a system diagram illustrating an embodiment of a group of wireless device that is interfering with a victim group.

FIG. 4A illustrates an embodiment where an uplink and downlink associated with a victim group are in different bands.

FIG. 4B illustrates an embodiment where an uplink and downlink associated with a victim group are in the same band.

FIG. 4C illustrates an embodiment with a spurious signal.

FIG. 5 is a flowchart illustrating an embodiment of an activation process.

FIG. 6 is a diagram showing an embodiment of quiet period coordination between beacon groups.

FIG. 7 is a system diagram illustrating an embodiment of a wireless device configured to avoid victim devices detected, if any.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

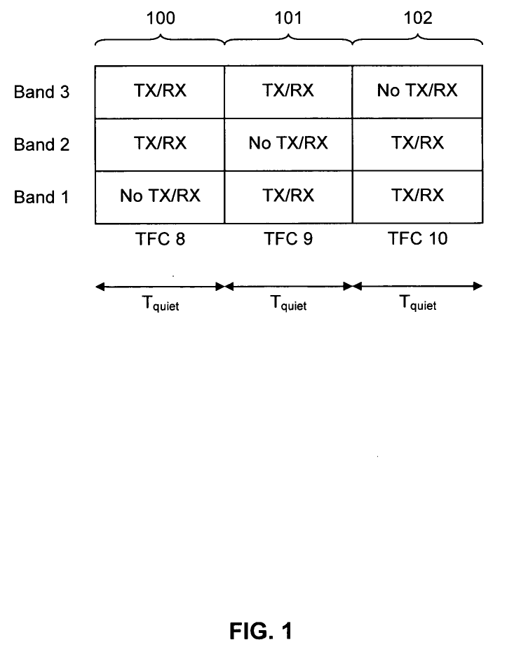

FIG. 1 is a diagram illustrating an embodiment of time frequency codes (TFC) cycled through in order to detect any victim devices. In the example shown, a group of one or more wireless devices is attempting to detect victim devices. In this particular example, the group is a group of WiMedia UWB wireless devices. The WiMedia specification defines a number of time frequency codes which can be used by a group of WiMedia UWB devices to communicate with each other. A TFC is more generally referred to as a channel. Table 1 lists the time frequency codes defined by WiMedia.

TABLE 1

| | |
|---|---|
| TFC Number | Band ID for TFC |

| | | | | | | |
|---|---|---|---|---|---|---|
| 1 | 1 | 2 | 3 | 1 | 2 | 3 |
| 2 | 1 | 3 | 2 | 1 | 3 | 2 |
| 3 | 1 | 1 | 2 | 2 | 3 | 3 |
| 4 | 1 | 1 | 3 | 3 | 2 | 2 |
| 5 | 1 | 1 | 1 | 1 | 1 | 1 |
| 6 | 2 | 2 | 2 | 2 | 2 | 2 |
| 7 | 3 | 3 | 3 | 3 | 3 | 3 |
| 8 | 1 | 2 | 1 | 2 | 1 | 2 |
| 9 | 1 | 3 | 1 | 3 | 1 | 3 |
| 10 | 2 | 3 | 2 | 3 | 2 | 3 |

In the example shown, all wireless devices in the group cycle through the time frequency codes TFC 8, TFC 9, and TFC 10 in that order. In some embodiments, some other sequence and/or number of time frequency codes is used.

Each time frequency code is occupied for T_{quiet}. For example, during period 100, TFC 8 is occupied for a duration of T_{quiet}. As shown in Table 1, bands 1 and 2 are used in TFC 8 whereas band 3 is not used. During period 101 (also T_{quiet} long), TFC 9 is used and bands 1 and 3 are used to exchange information and band 2 is not used. In period 102, TFC 10 is used, which means that bands 2 and 3 are used and band 1 is not used.

During each of periods 100-102, all wireless devices in the group listen for victim devices on the unoccupied band for that period. During period 100, they listen for any victim devices on band 1, during period 101 for any victim devices on band 2, and during period 102 for any victim devices on band 3. By cycling through TFC 8, 9, and 10, a victim device may be able to receive a downlink necessary to enable it to transmit. For example, if the downlink is on band 2, the victim device will be able to hear it during period 101 and will be able to transmit. As used herein, a victim device is a slave since only the slave device needs to listen for a downlink from the master (e.g., base station) before transmitting; master does not listen before transmitting.

In the case of WiMedia wireless devices, time is divided into superframes and each wireless device in a particular group keeps track of time and knows when a superframe starts. In some embodiments, T_{quiet} is an integer number of superframes.

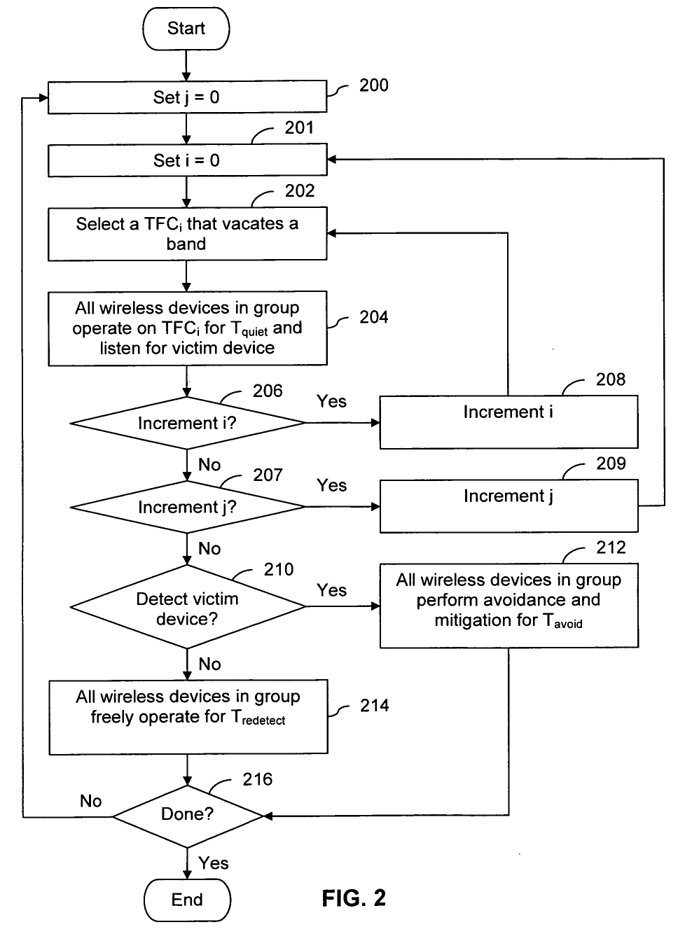

FIG. 2 is a flowchart illustrating an embodiment of a process to detect victim devices while cycling through time frequency codes. In the example shown, the process is performed by each wireless device in a group of wireless devices.

At 200, j is set to 0 and at 201, i is set to 0. At 202, a TFCᵢ is selected that vacates a band. In this example process, i is used to track the current TFC in a sequence of TFC being cycled through. In FIG. 1 for example, TFC₀ is TFC 8, TFC₁ is TFC 9, and TFC₂ is TFC 10. Some TFCs that do not vacate a band (e.g., TFC 1 which includes bands 1-3) are not selected at step 202.

At 204, all wireless devices in the group operate on TFCᵢ for T_{quiet} and listen for victim device. In some cases it may take only one wireless device in a group to prevent a victim device from receiving a downlink signal necessary to transmit, so all wireless devices in the group use the same TFC in at least some embodiments.

It is determined at 206 whether to increment i. In some embodiments, this decision is based on a maximum value for i and the current value of i. In FIG. 1 for example, i is incremented if it is less than or equal to 1 because i=0, 1, or 2 for this particular example. If so, i is incremented at 208 and a TFCᵢ that vacates a band for the incremented value of i is selected at 202. Otherwise, it is determined at 207 whether to increment j. In this example, j is used to track the number of iterations a sequence of TFCs has been cycled through. For example, if the sequence of TFC 8, TFC 9, and TFC 10 is to be cycled through twice, j would be incremented if it is equal to 0. Alternatively, if a maximum or predetermined number of detect iterations (N_{quiet}) has been reached, j would not be incremented.

If it is determined to increment j at 207, that is performed at 209 and also i is (re)set to 0 at 201. Otherwise, it is determined if a victim device has been detected at 210. In some embodiments, wireless devices A-C (302-306) each communicate to their neighbors whether a victim has been detected and, if so, the band it was detected in. In such embodiments, a decision at 210 is also based on whether a neighbor has detected a victim.

If a victim device is detected, all wireless devices in the group perform avoidance and mitigation for T_{avoid} at 212. In one example, WiMedia group 300 will use the TFC that caused or resulted in the victim being detected (e.g., if the victim was detected using a certain value of i, TFCᵢ is used). In some embodiments, after a T_{avoid} period ends, a new detection process is performed, for example by repeating the example process of FIG. 2.

If a victim device is not detected, all wireless devices in the group freely operate for T_{redetect} at 214. In some embodiments, the group remains on the same sequence of TFCs used to detect victim devices. For example, it may be easier and/or more convenient to stay on the same sequence and at some point in the future the group may perform a detection process again (e.g., repeat the process shown in FIG. 2 or some other process). In some embodiments, a group switches to a new TFC during a T_{redetect} period.

At 216, it is determined if a process is done. In some embodiments, a group of wireless devices periodically scans for victim wireless devices. In some embodiments, a detection process is manually triggered or initiated, for example by a user or upper layer driver or application.

Table 2 shows some example values for parameters used in the example process of FIG. 2.

TABLE 2

| Parameter | Value |
|---|---|
| T_{quiet} | 7 superframes (~450 ms) |
| N_{quiet} | 5 iterations |
| T_{avoid} | 6,000 superframes |
| T_{redetect} | Adaptive |

For example, if a sequence of TFC 8, TFC 9, and TFC 10 is used, detection (e.g., steps 200-210) takes (3*7*5)=105 superframes using the example values from Table 2.

In some embodiments, T_{redetect} adapts or otherwise changes based on the amount of confidence or information about the wireless environment. For example, when a wireless device in the group initially power up, T_{redetect} is set to a minimum value (possibly zero). With growing number of iterations with no victim device detected T_{redect} is progressively increased. In some embodiments, as the group of wireless devices exchanges information amongst the group, T_{redetect} adapts based on the group's collective knowledge or confidence. In some embodiments, confidence or information about the wireless environment is received from a device collocated with a WiMAX radio or other radio configured to properly receive and process a signal from a potential victim.

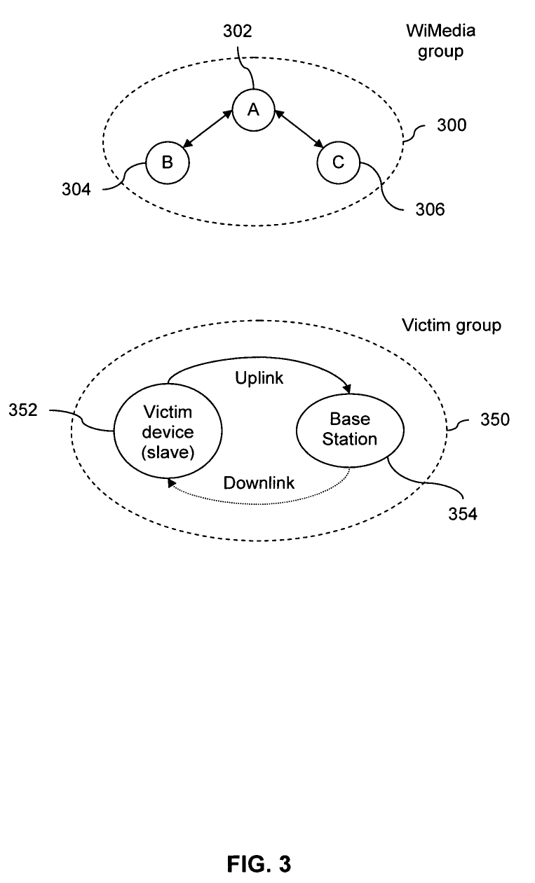

FIG. 3 is a system diagram illustrating an embodiment of a group of wireless device that is interfering with a victim group. In the example shown, WiMedia group 300 includes wireless device A-C (302-306) and victim group 350 includes victim device 352 (a slave) and base station 354. WiMedia group 300 operates in the vicinity of victim device 352 and any downlink to victim device 352 is susceptible to interference from WiMedia group 300. That is, victim device 352 will not be able to transmit if it cannot properly receive a downlink from base station 350 because of interference from wireless devices A-C 302-306. Base station 354 may or may not be in the same vicinity as WiMedia group 300. The following figures show some embodiments of how WiMedia group 300 and/or victim group 350 operate in various scenarios, including when the uplink and downlink are in different bands, the same band, or there is a spurious signal and no uplink or downlink. In this disclosure we assume a very basic detection scheme based on signal energy detection and hence some of the techniques discussed below apply appropriately. There may be other detection schemes wherein the WiMedia system could differentiate between uplink, downlink and spurious signal energy.

In some embodiments, WiMedia group 300 only attempts to detect a single signal, for example the uplink from victim device 352 and base station 354. In some embodiments, WiMedia group 300 (e.g., if possible and/or when desired) attempts to detect two signals, such as both the uplink and downlink signal.

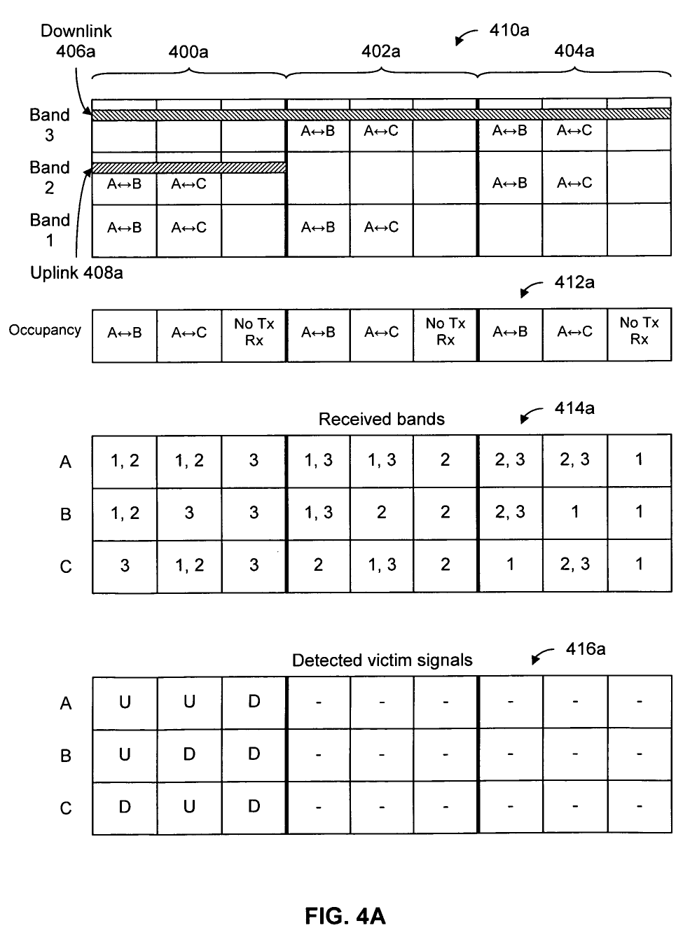

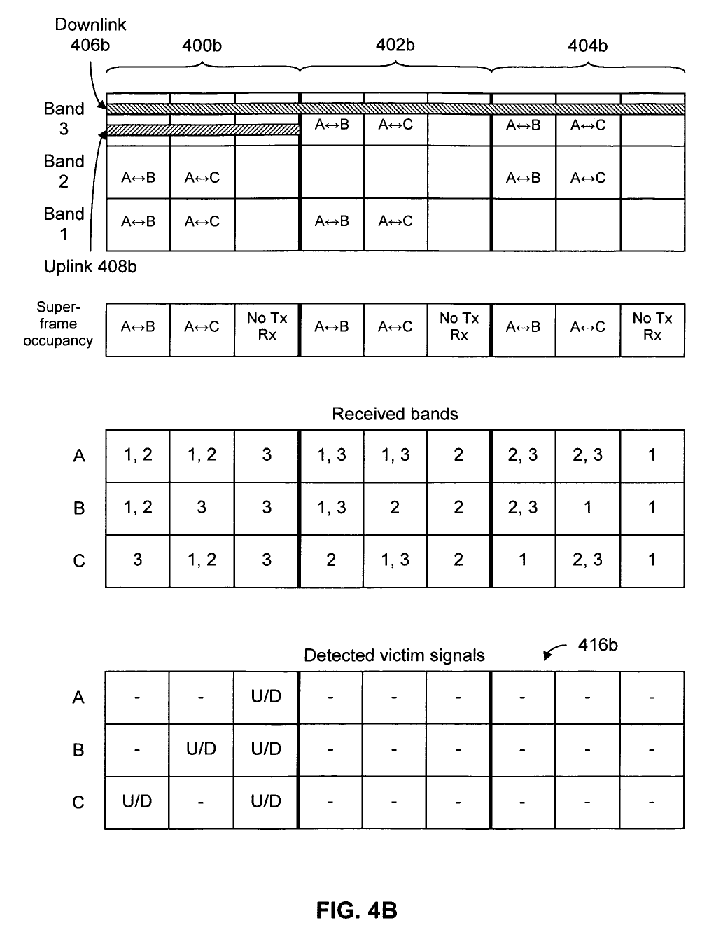

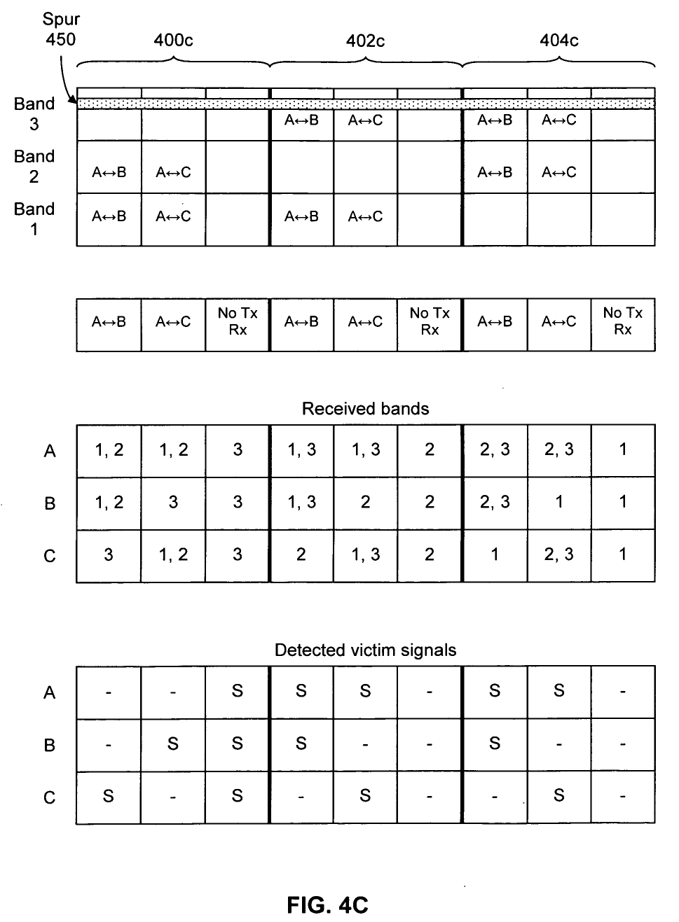

FIG. 4A illustrates an embodiment where an uplink and downlink associated with a victim group are in different bands. In the example shown, diagram 410a shows which wireless devices in WiMedia group 300 are operating in a particular band at a particular time. Time frequency diagram 410a also shows that downlink 406a is in band 3 and occurs in periods 400a thru 404a and uplink 408a is in band 2 and occurs in period 400a. During period 400a, wireless devices A-C (302-306) are not transmitting in band 3. As a result, victim device 352 is able to receive downlink 406a from base station 354 and transmits uplink 408a. If victim device 352 was not able to properly receive and process downlink 406a, it would not transmit uplink 408a and wireless devices A-C (302-306) would not be able to detect it since there would be no transmission from victim device 352.

Diagram 412a is a single dimension (i.e., time) diagram showing which devices in WiMedia group 300 are actively communicating with each over at particular periods of time.

Diagram 414a shows the received bands for each wireless device in WiMedia group 300 in the time and frequency domain. In this particular embodiment, detection is performed continuously and the particular band(s) being monitored depend upon whether a device is involved in an active transfer. For example, for devices actively involved in data exchange, detection is performed only in the bands that are part of the TFC in use. Devices not actively involved in a data exchange monitor a vacant band. To illustrate, consider period 400a (TFC 8) in which bands 1 and 2 are used and band 3 is not. During the first part of period 400a, wireless devices A and B are actively communicating and those devices receive signals in and perform detection on bands 1 and 2. Wireless device C is not actively involved in a data exchange during the first part of period 400 and receives band 3 (the vacant band during that time). During the second part of period 400a, wireless devices A and C are communicating with each other in bands 1 and 2 and those devices therefore receive bands 1 and 2. Wireless device B is not actively involved in a data exchange during the second part of period 400a and receives band 3 in an attempt to detect victim signals. In the third part of period 400a, there is no active communication between the WiMedia devices and all of the devices receive band 3, the vacant band for TFC 8.

Diagram 416a shows the detection results for each of the wireless devices in WiMedia group 300 in the time and frequency domain. In the example shown, a U indicates uplink 408a was detected, a D indicates downlink 406a was detected, and a dash indicates nothing was detected. In this example, the third column of 416a shows a D and not U/D because only Band 3 is monitied during that period because under the example conditions it is assured that there will be no WiMedia transmissions in that band. Some other embodiments are implemented in some other manner. Furthermore, this example considers the worst case scenario (i.e. when a downlink signal is very weak). In some other scenarios (e.g., closer to the base station) a wireless device is able to “hear” a downlink D signal. In some embodiments, a wireless device might not necessarily know whether a detected victim signal is an uplink signal as opposed to a downlink signal. For example, wireless device A detects a victim transmission during the first part of period 400a but may not necessarily know or care that it is an uplink signal. Any appropriate technique (e.g., involving energy levels, signal processing, etc.) may be used by a wireless device to process a received signal or band and decide whether or not a victim signal has been detected.

In this example and the examples described below, let us suppose downlink 406a is not detectable by the wireless devices because the base station is located at a large distance from the WiMedia devices. As a result, the downlink 406a will not be detected and the corresponding uplink 408a can only be detected during period 400a and cannot be detected during periods 402a and 404a since there is a WiMedia signal in band 3 during those periods which prevents the client device from being ‘authorized’ to transmit. Alternatively, in other embodiments, a downlink signal is able to be detected even if a WiMedia or other signal is in the same band under certain conditions. For example, base station 354 may be located relatively close to WiMedia group 300 and wireless devices A-C (302-306) are able to receive a strong downlink signal. In such cases the downlink 406a is detectable for all periods 400a, 402a and 404a since the base station is continuously broadcasting to all serviced clients. For a WiMedia device using simple energy detection this signal may look like a DL signal or a spur. Differentiating between these 2 cases would require monitoring the corresponding UL signal which would tend to ‘appear’ during quiet periods where the DL band is vacated and ‘disappear’ when the DL band is in use by the WiMedia devices.

As for the uplink signal, in this example and the examples described below, it is able to be detected by a wireless device even if a WiMedia signal is in the same band. For example, wireless device A is able to detect uplink 408a even though there is a WiMedia signal also in band 2 during the first and second parts of period 400a. UL signal would tend to ‘appear’ during quiet periods where the DL band is vacated and ‘disappear’ when the DL band is in use by the WiMedia devices.

FIG. 4B illustrates an embodiment where an uplink and downlink associated with a victim group are in the same band. In the example shown, WiMedia group 300 is configured to operate in the same manner as in the previous example of FIG. 4A, except uplink 408b is in band 3 as opposed to band 2. Downlink 406b remains in band 3. For brevity, some parts of FIG. 4B will not be discussed since they are similar to or the same as in FIG. 4A.

Diagram 416b shows the victim signals detected in this example configuration. In this example a U/D indicates uplink 408b and/or downlink 406b was detected. Since uplink 408b is in band 3, wireless devices A-C will only be able to detect uplink 408b during period 400b (since band 3 is not used in TFC 8) and each wireless device will only be able to detect uplink 408b when they are not actively exchanging data. For example, this is the third part of period 400b for wireless device A, the second and third parts of period 400b for wireless device B, and the first and third parts of period 400b for wireless device C. As in the previous figure, the group of wireless devices is not able to detect a downlink signal if there is a WiMedia signal in the same band. As a result, downlink 406b is not detected in this example during periods 402b and 404b even though it is transmitting during those periods.

FIG. 4C illustrates an embodiment with a spurious signal. In the example shown, a spurious signal (a.k.a spur) is some noise. In some cases, a spur is a transmission from a wireless device that does not listen for a special or certain signal (such as a downlink) before transmitting. In this example, spur 450 is able to be detected even if a WiMedia signal is in the same band. For example, the spur may be transmitted by a wireless device relatively nearby and the signal strength of spur 450 is relatively strong. As a result, spur 450 is detected by wireless devices A-C at various periods of time in periods 400c-404c.

As shown in FIG. 4C, in some cases a wireless device may detect a signal that is not actually from a victim device. WiMedia group 300 is trying to avoid victim group 350 or some other group that behaves in a similar manner (i.e., listens for a particular signal before transmitting), but not necessarily other devices that behave in some other manner. The following tables show some embodiments for deciding, based on detected signals, whether a spur or a genuine victim has been detected and if so, what band a downlink is in. In some embodiments, decision logic shown in Table 3 and/or Table 4 is used in step 210 of FIG. 2 to determine whether a victim device has been detected.

TABLE 3

| | Period | | | |
|---|---|---|---|---|
| | 400 | 402 | 404 | |
| | TFC 8 | TFC 9 | TFC 10 | |
| | Band 3 | Band 2 | Band 1 | |
| | vacated | vacated | vacated | Decision |
| Case 1 | Signal | Signal | Signal | Downlink in band 3 |
| | detected? | detected? | detected? | |
| | Yes | No | No | |
| Case 2 | Signal | Signal | Signal | Downlink in band 2 |
| | detected? | detected? | detected? | |
| | No | Yes | No | |
| Case 3 | Signal | Signal | Signal | Downlink in band 1 |
| | detected? | detected? | detected? | |
| | No | No | Yes | |
| Case 4 | Signal | Signal | Signal | Spur |
| | detected? | detected? | detected? | |
| | Yes | Yes | Yes | |

In Table 3, four possible cases are shown. For each of the possible cases, it is shown whether a signal is detected in any band by any device for time periods 400, 402, and 404, respectively. A decision is then made about whether there is a genuine victim device and, if so, what band the downlink is in. The band for the downlink must be determined because that is the band that must be avoided by the WiMedia devices in order for a victim device to receive the downlink and be able to transmit. The decisions made in Table 3 are made under the following conditions or assumptions:
There is one victim client and multiple base stations
An uplink signal will be present when a WiMedia group avoids using a band in which a downlink signal is located
Synchronization lost and reconnection times for a victim service<T_{quiet}
Reliable uplink detection using basic energy detection
No WiMedia device operates for 100% of the time (e.g., 100% of period 400, 402, or 404)
Spurs are constantly present during a quiet period

In Table 3, if a signal is detected in one and only one of periods 400-404, the vacated band that corresponds to that period contains the downlink. In cases 1-3, a signal is detected in one and only of the periods which correspond to vacated bands 3-1, respectively. The decision in cases 1-3 is therefore that an uplink is in bands 3-1, respectively. In case 4, a signal is detected in all of periods 400-404. Since a downlink does not change bands, the detected signal cannot be an uplink since at some point during periods 400-404 the WiMedia devices would prevent a victim device from properly receiving a downlink, thus preventing it from transmitting an uplink. The decision in case 4 is that there is a spur. In some embodiments, if a signal is detected in two or more of periods 400-404, the decision is that there is a spur.

In some cases, multiple signals are detected. Table 4 shows an example of the same four cases as in Table 3 and the decisions for those cases.

TABLE 4

| | Period | | | |
|---|---|---|---|---|
| | 400 | 402 | 404 | |
| | TFC 8 | TFC 9 | TFC 10 | |
| | Band 3 vacated | Band 2 vacated | Band 1 vacated | Decision |
| Case 1 | Signal 1 | Signal 1 | Signal 1 | Downlink in |
| | detected? | detected? | detected? | band 3 |
| | Don't care | Don't care | Don't care | |
| | Signal 2 | Signal 2 | Signal 2 | |
| | detected? | detected? | detected? | |
| | Yes | No | No | |
| Case 2 | Signal 1 | Signal 1 | Signal 1 | Downlink in |
| | detected? | detected? | detected? | band 2 |
| | Don't care | Don't care | Don't care | |
| | Signal 2 | Signal 2 | Signal 2 | |
| | detected? | detected? | detected? | |
| | No | Yes | No | |
| Case 3 | Signal 1 | Signal 1 | Signal 1 | Downlink in |
| | detected? | detected? | detected? | band 1 |
| | Don't care | Don't care | Don't care | |
| | Signal 2 | Signal 2 | Signal 2 | |
| | detected? | detected? | detected? | |
| | No | No | Yes | |
| Case 4 | Signal 1 | Signal 1 | Signal 1 | Spur |
| | detected? | detected? | detected? | |
| | Yes | Yes | Yes | |
| | Signal 2 | Signal 2 | Signal 2 | |
| | detected? | detected? | detected? | |
| | No | No | No | |

As in the previous example, if a signal is detected in all of periods 400-404, the decision engine determines there is a spur. In some cases (not shown in Tables 3 and 4) if a signal is detected for two or more periods, a decision engine determines there is a spur.

In some embodiments, each wireless device in a group has a decision engine employing the logic shown in Table 3 and/or Table 4.

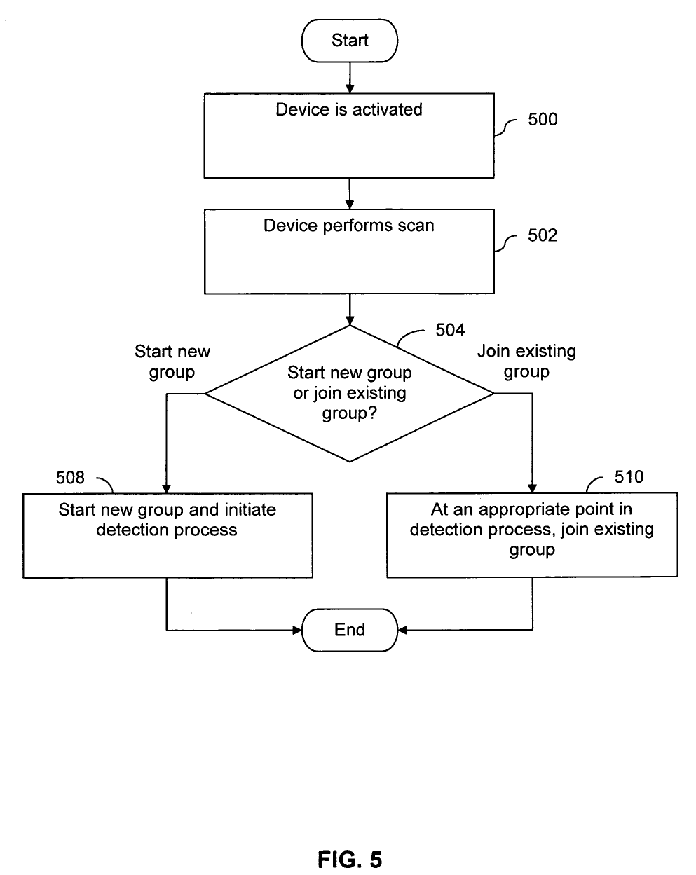

FIG. 5 is a flowchart illustrating an embodiment of an activation process. In the example shown, a device is activated at 500. In one example, the device is a WiMedia device and the WiMedia device is powered on. At 502, the device performs a scan. Any appropriate scanning technique can be used. In some embodiments, a device listens on each band for a predefined or sufficient amount of time (e.g., N superframes so that that if any existing group is using that band, they will pass through the band during at least one of the N superframes). In some embodiments, control frames (beacons) or other messages that are received are parsed to obtain any management or control information contained therein.

At 504 it is determined whether to start a new group or join an existing group. In some embodiments, if no existing group is detected (e.g., if no beacon is received) a new group is started. Based on the result of the decision at 504, a new group is started and a detection process is started at 508 or an existing group is joined at an appropriate point in a detection process at 510. In some embodiments, the detection process shown in FIG. 2 is used in step 508 and/or step 510.

In various embodiments, an appropriate point in a detection process to join an existing group at step 510 is: during a T_{quiet} when an existing group is operating on a TFC that vacates at least one band (e.g., step 204 in FIG. 2), during a T_{avoid} when an existing group is avoiding a victim device (e.g., step 212 in FIG. 2), and/or during a T_{redetect} after an existing group has determined there is no victim device and is freely operating (e.g., step 214 in FIG. 2).

In some embodiments, two (existing) beacon groups come into range of one another. The following figure shows one example of two beacon groups, initially with different timing and/or different TFC cycles, synchronizing so they cycle through the same sequence of TFCs at the same time to coordinate detection.

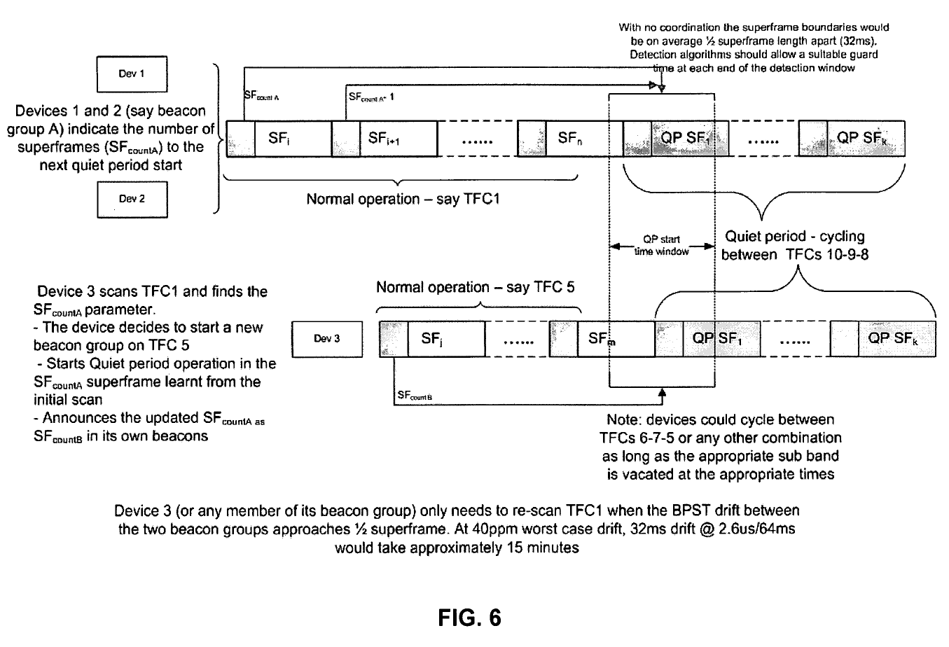

FIG. 6 is a diagram showing an embodiment of quiet period coordination between beacon groups. In some embodiments, a WiMedia device scans all TFCs before starting operation. If it finds an existing group of WiMedia devices operating it determines the time at which the next T_{quiet} period begins. In some embodiments this may be by receiving control information in the beacons of the existing WiMedia group The WiMedia device begins operation on its selected TFC and in some embodiments announces the start of its next T_{quiet} period to coincide with that of the detected WiMedia group. The coordination of T_{quiet} periods allows the detection procedures described to operate with multiple co-located WiMedia device groups. Relative timing changes may require periodic re-scanning of the co-located group operating on a different TFC to re-align the Tquiet periods

Some wireless devices may not necessarily be able to perform all of the steps in the techniques described above. The following figure describes some changes to be made to an existing design or system in order to be able to perform the detection and/or avoidance techniques described above.

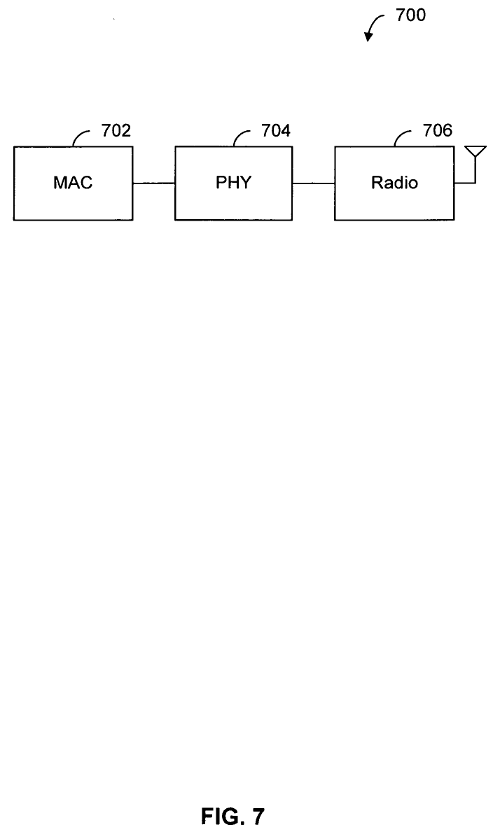

FIG. 7 is a system diagram illustrating an embodiment of a wireless device configured to avoid victim devices detected, if any. In some embodiments, wireless device 700 is a WiMedia device (such as wireless devices A-C (302-306) shown in FIG. 3).

Wireless device 700 includes Media Access Controller (MAC) 702, physical layer processor (PHY) 704, and radio 706. PHY 704 in some cases is also referred to as a baseband processor.

In some embodiments, PHY 704 is configured to have victim detection capabilities and (if needed) is able to be instructed when to change to a given channel (such as TFC 8, TFC 9 or TFC 10), for example to begin detection scanning, and/or so it can be instructed on the dwell time on given TFC, for example after detection. Some more detailed examples are described below.

In some applications it would be useful if an interface between MAC 702 and PHY 704 were defined in some specification, such as the WiMedia specification. For example, this would allow different (e.g., ASIC or FPGA) manufactures to build MAC 702 and PHY 704 that are capable of interoperating.

In some embodiments, PHY 704 is modified to include a ‘Start Detection’ control register, a duration register for a (e.g., detection) channel dwell time, and/or a detection success or failure indication (e.g., an interrupt, register, ASIC or FPGA output, etc.).

In some embodiments, MAC 702 is modified to include a re-detect engine to synchronize each member of a group to initiate a re-detect operation at the same time. In some embodiments, existing protocols from a MAC specification (such as the WiMedia MAC specification) are used to support the re-detect operation. For example, the WiMedia MAC Channel Change mechanism may be used to signal a group of devices to change TFC in a coordinated manner thus synchronizing the re-detect operation. In some embodiments, a priority mechanism similar to the DRP conflict resolution mechanism is used to resolve any conflicting re-detect indications.

In some embodiments, MAC layer management entity (MLME) abstractions are defined or otherwise created for the transfer of DAA parameters and/or MAC operations. Some examples include a Start_ReDetect(superframe_countdown) to allow a MLME to manage detection rescan intervals (in this example specified in units of superframes), a DAA_Channel_Change(TFC)—to allow different TFC sequences in different regions of the world, and/or a Reset/Abort detection mechanism to avoid long delays in PHY or MAC response to MAC operations such as channel change. In some embodiments, an MLME is configured to manage all DAA procedure timing. In some applications this may be desirable because it avoids having to specify explicit DAA protocol operation in the MAC.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for detecting a victim wireless device, comprising:
obtaining a set of wireless bands and a set of time periods, wherein during a given time period a subset of wireless bands corresponding to that time period is vacant and a remaining subset of wireless bands is used to exchange data;
during each of the time periods in the set of time periods:
receiving a signal, if any; and
in the event a signal is received, recording the subset of vacant wireless bands corresponding to that time period; and
after the set of time periods ends, determining whether there is a victim wireless device based at least in part on the number of vacant wireless bands recorded.

2. The method as recited in claim 1, wherein the method is performed by an ultra wideband (UWB) wireless device.

3. The method as recited in claim 2, wherein the UWB wireless device includes a WiMedia UWB wireless device.

4. The method as recited in claim 1, wherein it is determined there is a victim wireless device if the number of vacant wireless bands is one.

5. The method as recited in claim 4, wherein the number of vacant wireless bands is one includes a sole vacant wireless band recorded a plurality of times.

6. The method as recited in claim 1, wherein:
a base station transmits a downlink to the victim wireless device on one of the wireless bands in the set of wireless bands; and
the victim wireless device is configured to not transmit unless the downlink is received.

7. The method as recited in claim 1, wherein each of the set of time periods is a positive integer number of superframes long.

8. The method as recited in claim 1, wherein the method includes repeating a sequence of time frequency codes (TFCs) a plurality of times.

9. The method as recited in claim 1, further including during each of the time periods in the set of time periods: tuning a receiver to one or more of the subset of wireless bands used to exchange data during a period in which a wireless device performing the method is involved in exchanging data.

10. The method as recited in claim 1, further including during each of the time periods in the set of time periods: tuning a receiver to one or more of the subset of vacant wireless bands during a period in which a wireless device performing the method is not involved in exchanging data.

11. The method as recited in claim 1, further including not exchanging data on the recorded subset of vacant wireless bands in the event it is determined there is a victim wireless device.

12. The method as recited in claim 1, further including exchanging data in the set of wireless bands in the event it is determined there is a victim wireless device.

13. The method as recited in claim 1, further including:
activating a wireless device;
processing a receive signal to detect an existing group of wireless devices, if any; and
in the event an existing group of wireless devices is detected, joining the group of wireless devices.

14. The method as recited in claim 13, further including starting a new group of wireless devices in the event an existing group of wireless devices is not detected.

15. A system for detecting a victim wireless device, comprising:
an interface configured to obtain a set of wireless bands and a set of time periods, wherein during a given time period a subset of wireless bands corresponding to that time period is vacant and a remaining subset of wireless bands is used to exchange data; and
a signal processor which is configured during each of the time periods in the set of time periods to:
receive a signal, if any; and
in the event a signal is received, record the subset of vacant wireless bands corresponding to that time period; and
after the set of time periods ends, determine whether there is a victim wireless device based at least in part on the number of vacant wireless bands recorded.

16. A computer program product for detecting a victim wireless device, the computer program product being embodied in a computer readable storage medium and comprising computer instructions for:
obtaining a set of wireless bands and a set of time periods, wherein during a given time period a subset of wireless bands corresponding to that time period is vacant and a remaining subset of wireless bands is used to exchange data;
during each of the time periods in the set of time periods:
receiving a signal, if any; and
in the event a signal is received, recording the subset of vacant wireless bands corresponding to that time period; and
after the set of time periods ends, determining whether there is a victim wireless device based at least in part on the number of vacant wireless bands recorded.
